(19) United States
(12) Patent Application Publication
(10) Pub. No.: US 2006/0096710 A1
(43) Pub. Date: May 11, 2006

(54) Roll and printer

(75) Inventors: Katsuhide Tsukamoto, Tokyo (JP); Hiroshi Hirase, Tokyo (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: LINTEC CORPORATION, Tokyo (JP)

(21) Appl. No.: 11/265,299

(22) Filed: Nov. 3, 2005

(30) Foreign Application Priority Data
Nov. 8, 2004 (JP) 2004-323634

(51) Int. Cl. B32B 37/00; B65C 11/02

(52) U.S. Cl. 156/384; 492/60; 156/378

(57) ABSTRACT

A printer 10 is arranged to include a pay-out section 12 for a strip of label sheet M having label base LB, a printing section 14 for printing on the surface of the label base LB, a film feeder 16 for supplying a protective film F and a sticking section 18 for sticking the protective film F to the label base LB. The sticking section 18 comprises a press roll 50 and a platen roll 51, the press roll 50 is arranged to include a soft member 54 on the peripheral portion of the roll body 52 and cutter blades 55A, 55B. The sticking section 18 sticks the protective film F as well as forms a cut C in the label sheet M and the protective film F corresponding to the configuration of the label L.

### BACKGROUND OF THE INVENTION

1. Field of the Invention

The present invention relates to a roll and a printer, particularly to a roll, which is suitable for performing printing on a strip for label base temporarily stuck on a release liner, sticking a strip of protective film onto the printed surface and forming a cut having a label shape, and a printer capable of obtaining labels one by one using the roll.

2. Description of the Related Art

Patent document 1 (Japanese Patent Application Laid-Open No. 2000-103420) discloses a printer capable of printing on the surface of a label. This printer employs the following arrangement; i.e., using a label sheet in which labels previously formed into a label shape are temporarily stuck at prescribed intervals on one surface of a strip of release liner, a printing is carried out in process of paying but the label sheet. The following arrangement is also employed; i.e., a film formed in an appropriate size to protect the printed surface is peeled off from the release liner and stuck to the printed label.

However, each of the label and the protective film used in the printer disclosed in the Patent document 1 are previously formed into a prescribed shape and temporarily stuck onto a strip of base sheet at prescribed intervals, that is, the following arrangement is not employed; i.e., a cut with a label shape is formed in process of paying out the strip of label and protective film. Although the label can be manufactured by sticking the protective film onto the printed surface after carrying out the printing on the surface of the label, this arrangement requires an operation of forming a strip of label base and a protective film into a prescribed label shape in the preceding process, which needs another dedicated apparatus therefor.

To eliminate such preceding process and apparatus, using a strip for label base and a protective film on which label shapes have not been formed in advance, a cut is formed corresponding to a prescribed label shape after performing printing on the label base surface and sticking a protective film thereon.

However, to employ such arrangement, a die cut roll or the like for forming a cut of a label shape is required at the downstream side of the sticking roll in addition to a sticking roll for sticking a protective film to the label base, which causes a disadvantage that a longer space is required for disposing components along a pay-out path and hence miniaturization of the apparatus is blocked.

Also, the printer disclosed in the Patent document does not have an arrangement to detect printing faults. Therefore, for example, assuming that the information to be printed on the label is individual identification items and a system is employed that labels having such information is to be stuck to the object conveyed sequentially along a conveyance path installed in the printer, the following disadvantages are brought about.

For example, in a case where the information such as manufacturing date, production number, production place, and serial number of the object stuck with the label is to be indicated on the label, printed labels by the printer have always the individual identifiable printing information. Production of the labels including such printing information is to be carried out corresponding to conveyance sequence of the object. Therefore, once a printing fault occurs, the label with printing faults is stuck intact.

Such printing fault may be detected visually by a worker. And the sticking of the label may be temporarily suspended, and a label printed with the same printing information may be issued again, and the label may be stuck onto the object. However, until a point of time of label reissuing, a considerable number of labels including successive individual identification information corresponding to the objects conveyed sequentially are to be issued one after another. That is, having a series of stock of labels between printing and discharging thereof, a time lag for reissuing the label can be long and also it can be difficult to identify which label has been reissued, resulting in a disadvantage of significant deterioration of operation efficiency.

### SUMMARY OF THE INVENTION

The present invention has been proposed in view of the above disadvantages. An object of the invention is to provide a roll, which is capable of forming a cut corresponding to the shape of the label in process of sticking a protective film to a label base, and a printer employing the roll.

Another object of the invention is to provide a printer, which is capable of automatically detecting printing fault, and when a printing fault is detected, the printer can print the repeated printing information instead of a successive printing information.

To achieve the above objects, the invention employs such an arrangement that a roll includes:

a soft member wound around the outer periphery of a roll body; and cutter blades disposed within an area of the soft member, wherein the roll sticks a protective film to a label base and forms a cut of a label shape.

The roll preferably employs an arrangement such that the height of the cutter blade is set to be lower than a surface height position of the soft member, and when the soft member receives a compression force, the cut is formed by the cutter blade.

The roll may be formed in a configuration including a relatively low height area of the cutter blade to form a projected portion serving as a sheet peel-off tip on a part of the peripheral edge of the label.

The invention employs such an arrangement that a printer includes:

a pay-out section for paying out a strip of label sheet temporarily stuck with a label base on one surface of a release liner;

a printing section for printing on the surface of the label base while paying out the strip of label sheet from the pay-out section;

a film feeder for supplying a strip of protective film to the printed surface side of the label base; and

a sticking section for sticking the protective film to the label base, wherein

the sticking section includes a press roll and a platen roll opposing to the press roll, wherein

the press roll is wound with a soft member on the peripheral portion of the roll body, and cutter blades are disposed within an area of the soft member,

when the label sheet and protective film pass through the sticking section, the protective film is stuck to the printed surface side and a cut corresponding to a prescribed label shape is formed.

In the printer, the printing section is arranged so as to print individual identifiable printing information on each label.

Also, the printer employs such an arrangement that a sensor is disposed at the downstream side of the printing section, when the sensor detects a printing fault, the printing information at the point of time when the printing has been judged as faulty printing is printed without printing a successive printing information.

Further, the printer employs such an arrangement that a plurality of the cutter blades are provided in the peripheral portion of the roll body, and a plurality of labels are formed by one rotation of the roll body.

Furthermore, the printer employs such an arrangement that, when the sensor detects a printing fault, the drive rotation of the press roll is temporarily stopped, and the release liner, label sheet and protective film are wound including the area of printing fault without forming the cut in the area of printing fault.

Still further, the printer may employ such an arrangement that, when the sensor detects a printing fault, the press roll shifts its axle and is held so as not to form the cut.

According to the invention; the roll-for sticking the protective film to the label base also has a function as a die cut roll. Therefore, the space (length) for disposing components along the pay-out path can be arranged to be shorter, compared with the conventional type in which the sticking roll and the die cut roll are provided separately in parallel. Moreover, since the length along the pay-out path can be reduced, the distance between the printing section and the sticking section can be arranged to be close to each other. Accordingly, the pitch between the labels can be set to be small to prevent waste of label base.

Also, since the cutter blade is arranged so as to be positioned lower than the surface height of the soft member, the sticking pressure of the protective film to the label base is securely obtained.

Further, adoption of a cutter blade capable of forming the projected portion in a part of peripheral edge of the label allows easy and swift operation of peeling off the release liner from the label.

Furthermore, such an arrangement is employed in the case where printing faults of the label base are detected, that the printing operation of the successive printing information is suspended and the repeated printing information is printed. Therefore, when the objects to be stuck with the label are conveyed corresponding to the printing sequence, it is not necessary to consider the relationship between the object and the reissued label. Accordingly, sticking of wrong labels can be prevented.

Still further, owing to such an arrangement that, when a printing fault is detected, the faulty label is wound without forming a cut, the issuing faulty label itself can be prevented.

Moreover, in a case where such an arrangement is adopted that the axle of the press roll shifts, a larger cleared space for performing winding operation of the label base and the like can be obtained, which can secure workability well.

### BRIEF DESCRIPTION OF THE DRAWINGS

FIG. 1 is a schematic front view of a printer in accordance with a first embodiment,

FIG. 2 is an enlarged perspective view schematically showing a principal portion in FIG. 1,

FIG. 3 is an enlarged front view of a sticking section showing a position where cutter blade does not form a cut,

FIG. 4 is an enlarged front view of a sticking section, showing a state where the cutter blade forms a cut,

FIG. 5 is a schematic front view of a printer in accordance with a second embodiment,

FIG. 6 is a schematic front view of a printer in accordance with a third embodiment,

FIG. 7 is a schematic front view of a printer in accordance with a fourth embodiment,

FIG. 8 is a schematic front view of a printer in accordance with a fifth embodiment,

FIG. 9(A) is a schematic front view of a printer in accordance with a sixth embodiment,

FIG. 9(B) is a schematic perspective view of a label obtained by the printer in accordance with the sixth embodiment, and

FIG. 10 is a schematic front view of a printer in accordance with a seventh embodiment.

### DETAILED DESCRIPTION OF THE PREFERRED EMBODIMENT

Hereinafter, preferred embodiments of the invention will be described with reference to the drawings.

### First Embodiment

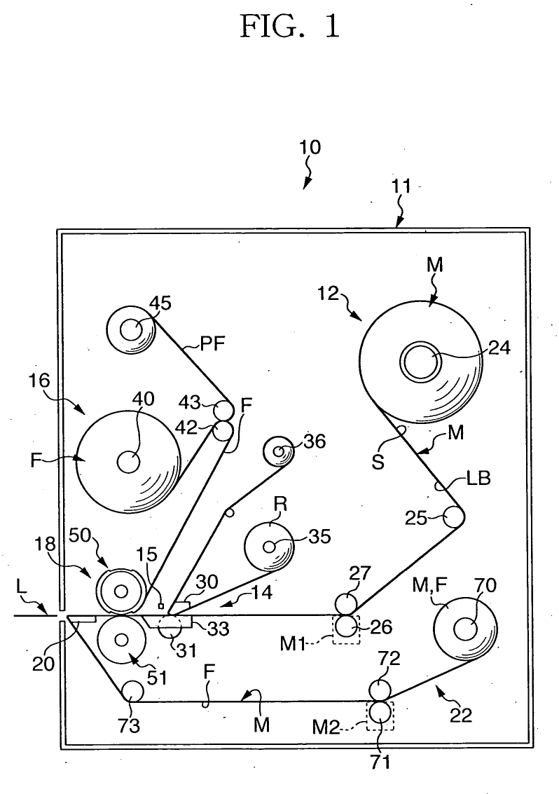

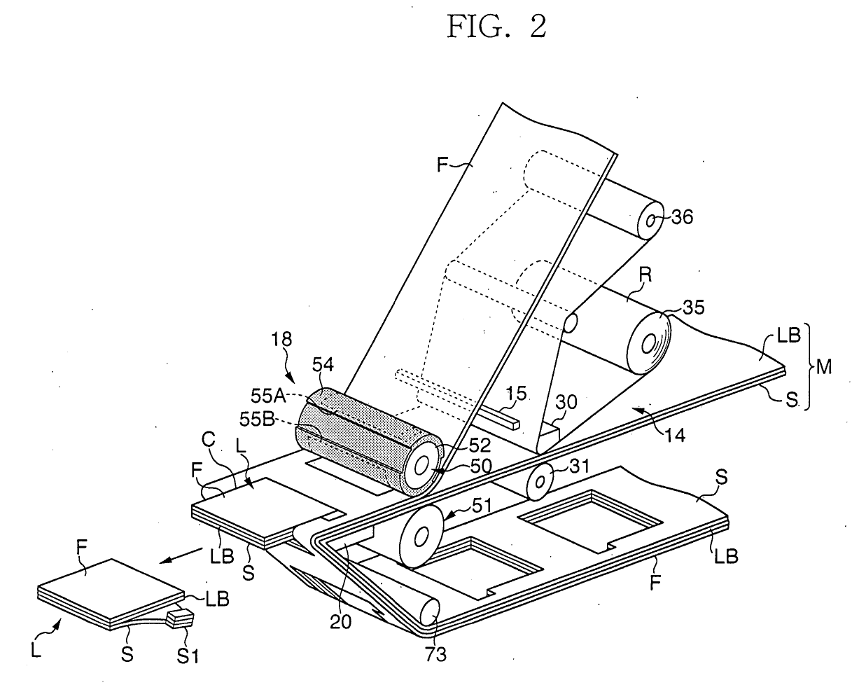

FIG. 1 is a schematic front view of a printer in accordance with a first -embodiment, and FIG. 2 is an enlarged perspective view schematically showing a principal portion thereof. Referring to the these drawings, a printer 10 is arranged to include a case 11, a pay-out section 12, which is provided in the case 11 to pay out a strip for label sheet M temporarily stuck with a label base LB on one surface of a release liner S, a printing section 14 for printing on the surface of the label base LB in process of paying out the label sheet M from the pay-out section 12, a sensor 15, which is disposed in the vicinity of the printing section 14 at the downstream side thereof to detect quality of printing, a film feeder 16 for supplying a strip of protective film F to the printed surface side of the label base LB, a sticking section 18 that sticks the protective film F to the label base LB and has a function to form a cut C (refer to FIG. 2) having a prescribed label shape, a plate member 20 for taking out a label L by sharply reversing the label sheet M stuck with a protective film F, and a winding section 22 to wind peripheral area remained after the label L has been removed as refuse.

The pay-out section 12 is arranged to include a holder roll 24 for holding the label sheet M having a roll-like shape enabling to pay out the label sheet M therefrom, a guide roll 25 for guiding the label sheet M paid out from the holder roll 24, a drive roll 26, which is disposed below the guide roll 25, and is driven to rotate by a motor M1, and a pinch roll 27 for pinching the label sheet M between the drive roll 26 and the same.

The printing section 14 is arranged to include a printing head 30 for printing prescribed information to be printed on the surface of the label base LB, a platen roll 31 disposed at the side of release liner S, a guide plate 33 for accommodating the platen roll 31 in a rotatable state and for supporting the release liner S from the lower surface side thereof, a ribbon pay-out roll 35 for paying out the ink ribbon R in a state being wound around the printing head 30, and a ribbon winding roll 36 for sequentially winding the ink ribbon R from which the ink has been transfer to the label base LB. A control unit including an input section and a display (these are not shown) are connected to the printer 10, so that variable information for identifying each of the objects to be stuck with the label L is sequentially printed in accordance with a prescribed program in the control unit. The variable information may be input through communication with a host computer or the like which is controlling the whole line including the printer 10.

The sensor 15 is for judging quality of the printed information on the surface of the label base LB by the printing section 14. The sensor 15 is arranged to include a sensor such as, for example, a bar code reader capable of reading variable information. When a printing fault is detected immediately after the printing head 30 has performed a printing, control signals are output to the control unit (not shown), which is arranged to suspend printing of the printing information including the succeeding variable information and to control so that the printing information judged as faulty printing is to be printed again.

The film feeder 16 includes a film holder roll 40 for holding a protective film F wound in a roll-like shape so as to pay out the film therefrom. The protective film F in this embodiment is stuck with a strip of release liner PF at the rear surface side thereof. The protective film F is arranged to be peeled off from the release liner PF after being paid out from the holder roll 40, and then used. To this end, a pair of peeling rolls 42 and 43 are disposed at a position beside the film holder roll 40, and the release liner PF is wound by a film winding roll 45 while the protective film F is arranged to be paid out toward the sticking section 18.

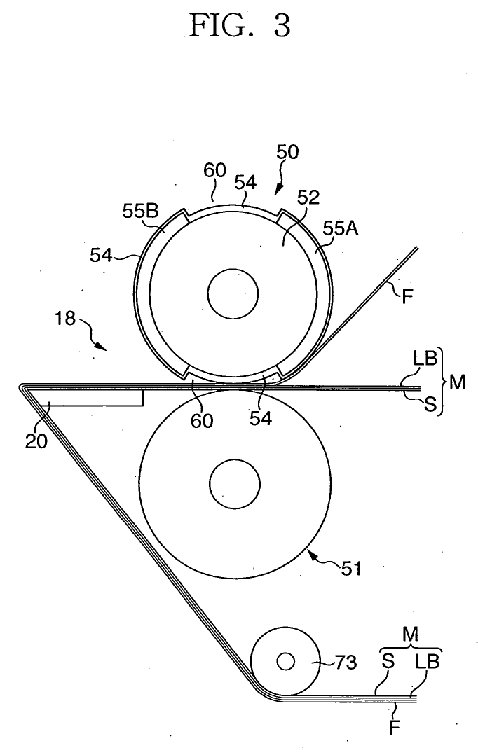

As shown in FIG. 2 and FIG. 3, the sticking section 18 includes a press roll 50 for sticking the protective film F to the printed surface of the label base LB and a-platen roll 51 opposing to the press roll 50 at the lower surface side of the release liner S. The press roll 50 includes a roll body 52, which is driven to rotate by a motor (not shown), a press sheet 54 made of EVA (ethylene vinyl acetate) or the like as a soft member, which is wound around the peripheral portion of the roll body 52, and a pair of cutter blades 55A and 55B, which are disposed on the roll body 52 at 180 degree interval in the peripheral direction and positioned inside of the surface of the press sheet 54 for forming a cut C corresponding to the shape of the label L in the protective film F, the label base LB and the release liner S. The press roll 50 is provided with a roll height adjusting mechanism (not shown) for adjusting the clearance between the platen roll 51 and the press roll 50, and a roll up/down mechanism (not shown) by means of an air cylinder for facilitating the label sheet M and the protective film F to go through between the rollers.

The cutter blades 55A and 55B are arranged so that, when the press roll 50 performs one rotation, cuts C are formed corresponding to two labels L with prescribed intervals from each other. Each of the cutter blades 55A and 55B is set to a position in which the front end (blade tip) thereof is slightly lower than the height of the surface of the press sheet 54 so that insufficient sticking pressure is given to the protective film F by the press sheet 54. As shown in FIG. 2, in this embodiment, the cutter blades 55A and 55B are arranged to include a blade portion, the height of which is relatively lower than that of the rest so that the label L is formed to include a projected portion S1, which serves as a peel-off tip in a part of the peripheral edge of the label L in the release liner S.

Between the cutter blades 55A and 55B, no-blade areas 60 are formed in prescribed areas along the peripheral direction, which are symmetrical with substantially 180 degree interval. The press sheet 54 in these no-blade areas 60 is formed to be thin in thickness so as to be lower than the height of the blade tip of the cutter blades 55A and 55B. Owing to this, as shown in FIG. 3, in a state that the rotation of the press roll 50 is stopped and one no-blade area 60 faces to the platen roll 51 side, the label sheet M and the protective film F are allowed to pass freely therethrough. In this embodiment, such control is arranged that, when the sensor 15 detects the above-described printing fault, the sensor 15 emits a signal to stop temporarily a motor (not shown) for rotating the press roll 50. Thereby, the area including the printing fault can be wound by the winding section 22 without forming a cut C corresponding to the label L in the area with the printing fault. The press roll 50 may be arranged so that, when the sensor 15 detects a printing fault, using a roll up/down mechanism by the above-described air cylinder (not shown), the position of the axle is shifted upward to prevent the cut C from being formed.

The plate member 20 is provided having a sharp angle shape front end so that the label L can be taken out sequentially by means of a winding force of winding section 22.

The winding section 22 includes a winding roll 70, a winding drive roll 71, which is positioned at the upper stream side than the winding roll 70 to be rotated by a motor M2, a pinch roll 72 for pinching the label sheet M and the protective film F from which labels L have been taken out between the winding drive roll 71 and the same, and a guide roll 73 disposed below the plate member 20. The winding roll 70 is connected with the output axle of the motor M2 (not shown) via a slide belt or the like; thereby, the winding roll 70 is rotatable synchronously with the winding drive roll 71.

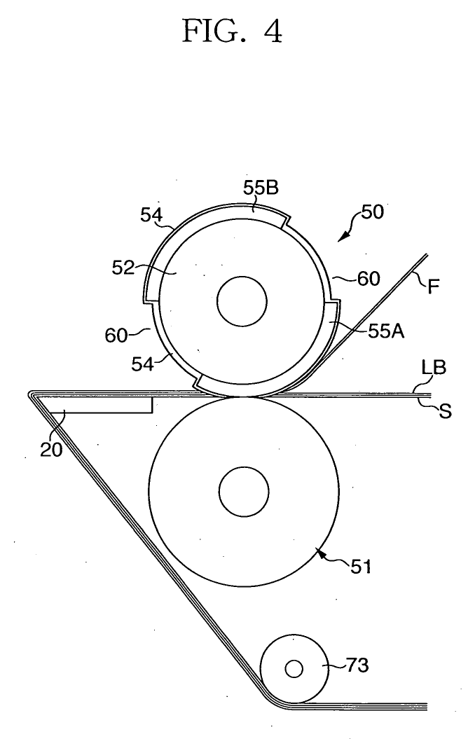

Next, label producing method in accordance with the embodiment will be described with reference to drawings including FIG. 4. Herein, it is assumed that the printer 10 is provided with a conveyance path (not shown), and objects to be stuck with the label L one by one are conveyed sequentially on the conveyance path. Further, it is assumed that each label L, which is discharged from the printer 10, is manually stuck to the object one by one by a worker after peeling off the release liner S; and the printing information, which is different for each object, is input via an input unit of the printer 10.

In the initial operation, the label sheet M held by the holder roll 24 is pulled out and passed through the sticking section 18; and the protective film F is peeled off from the release liner PF, and passed through the sticking section 18 and laminate each other, and the lead end thereof is fixed to the winding roll. And after fixing the lead end of the release liner PF to the film-winding roll 45, the power is turned on to wind a prescribed amount; thus the initial operation is completed.

When a switch of the control unit (not shown) is turned on, the pay-out of the label sheet M and the protective film F begins, and instantaneously printing information is printed by the printing section 14 via a prescribed program by the control unit. The sensor 15, which is positioned immediately after the printing head 30, detects the quality of the print. When the printing is carried out normally, the label base LB is stuck with the protective film F onto its printed surface at the position where the label base LB is paid out to the sticking section 18 along with the release liner S. At the same time, a cut C enclosing the printing area is formed by the cutter blades 55A and 55B (refer to FIG. 4).

Contrarily, when the sensor 15 detects a printing fault, as shown in FIG. 3, the press roll 50 is stopped at a position where the non-blade area 60 faces to the platen roll 51 and held as it is so as not to form any cut by the cutter blade 55A or 55B, and the label sheet M and protective film F are allowed to pass therethrough freely. The successive printing information is held not to be printed out, and when the printing information, which is identical to the information judged as faulty printing, is re-printed normally, the press roll 50 performs a rotation, thereby a cut C is formed and the label sheet M and protective film F are paid out forward. It may be arranged so that, using a roll up/down mechanism (not shown), the axle of the press roll 50 be shifted upward to suspend the forming of the cut C.

When the printing has been carried out properly, the label L, which is stuck with the protective film F and formed with the cut C, is taken out forward when the label L passes through the plate member 20, discharged out of the printer 10 and received by a worker. The worker picks the projected portion S1 of the release liner S and peels off the release liner S easily and swiftly from the received label L to stick the label L to the object.

According to the embodiment as described above, while protecting the printed surface with the protective film F, the cut C corresponding to the configuration of the label L can be formed. Therefore, it is not necessary to provide the sticking roll for the protective film F and the die cut roll for forming the cut C separately. Therefore, the space for components along the pay-out direction of the label L or the label sheet M can be arranged to be smaller. Accordingly, a short pitch can be set between the labels, and hence wasteful consumption of the label base is prevented and further, the printer 10 can be miniaturized.

Moreover, the following arrangement is employed. That is, when a printing fault is detected, the printing of the successive printing information is not carried out, and the printing of the printing information judged as fault is carried out again. Therefore, the labels L can be stuck in accordance with the sequence of the objects conveyed on the conveyance path. Accordingly, the sticking failure can be prevented and the operation efficiency can be significantly enhanced.

Next, other embodiments of the invention will be described below. In the following descriptions, the identical or equivalent arrangement to those in the first embodiment will be given the same reference numerals and descriptions thereof will be omitted or made just simply.

### Second Embodiment

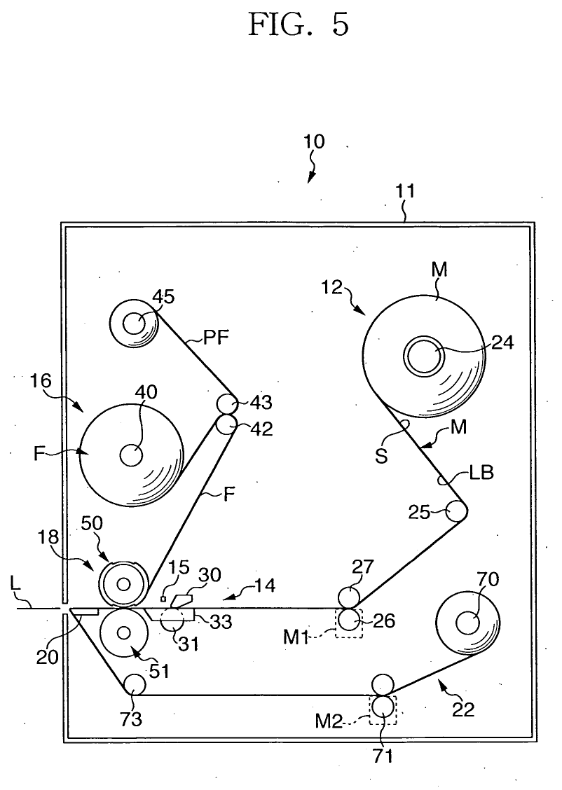

FIG. 5 schematically shows a front view of a printer 10 in accordance with a second embodiment of the invention. The second embodiment is characterized in that the printing on a label base LB can be carried out without using an ink ribbon. That is, in this embodiment, the label base LB is constituted of a thermo sensitive paper, and the printing is carried out by imparting heat of a prescribed pattern to the label base. LB using a printing head 30. Other arrangements are identical to those of the first embodiment.

According to the second embodiment as described above, since the ink ribbon is not used, the arrangement can be simplified by eliminating the rolls for paying out and winding the ribbon and also the operation of routing the ribbon can be eliminated. In the case of the thermo sensitive paper, the legibility of the printed surface may be lost due to a heat caused by rubbing for some reason on the surface. However, in this embodiment, since the protective film F is stuck, the legibility can be stably maintained.

### Third Embodiment

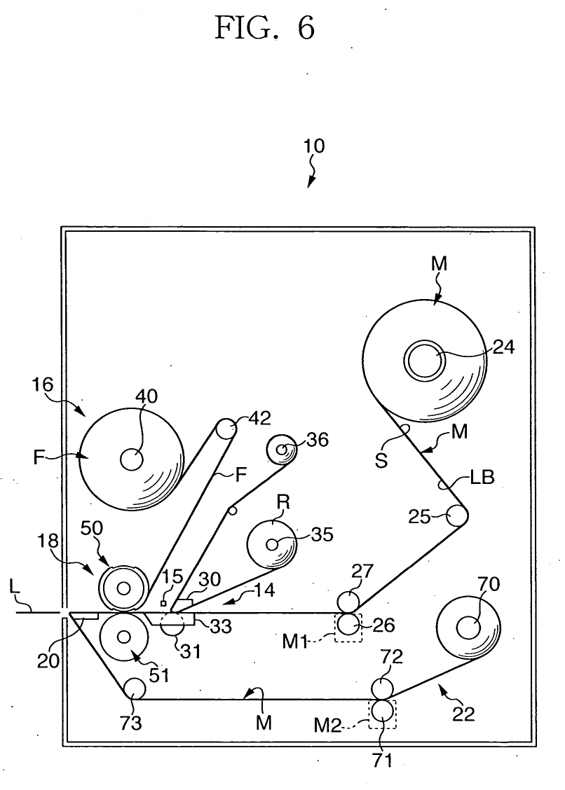

FIG. 6 shows a third embodiment in accordance with the invention. This embodiment employs a protective film F without release liner PF on the rear surface thereof. Owing to this, the running cost can be reduced for no release liner PF on the protective film F exists, and in addition the apparatus can be compacted because there is no film winding roll 45. Other arrangements are identical to those of the first embodiment.

### Fourth Embodiment

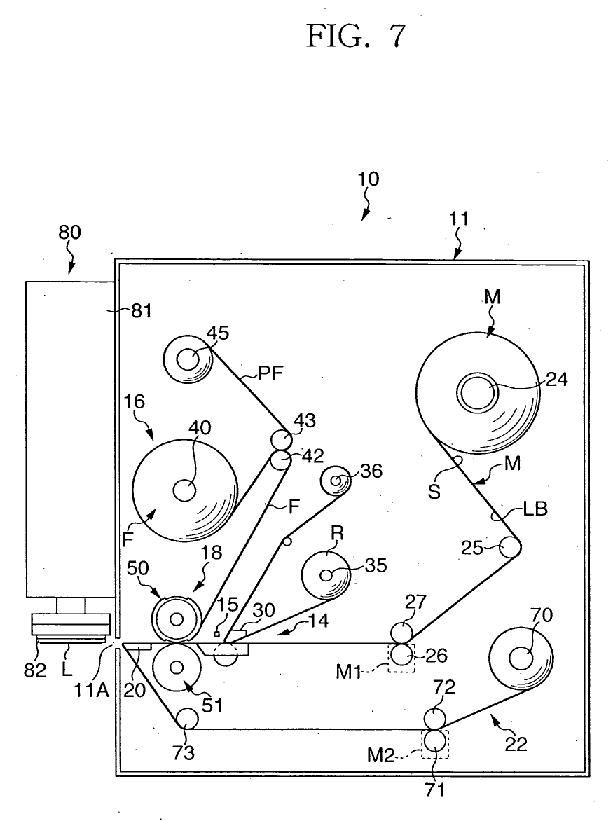

FIG. 7 shows a fourth embodiment of the invention. This embodiment is characterized in that a label sticking device 80 is provided on a side wall of the case 11 of the printer 10. The label sticking device 80 is arranged to include a cylinder 81 and a suction head 82 provided at a lower portion of the cylinder 81. The suction head 82 is positioned along the extension line of the label discharge port 11A of the case 11, and is arranged so as to suck the label L discharged from the label discharge port 11A and stick the label L to the sticking surface of the object (not shown) being conveyed below the suction head 82. In this embodiment, the cut C is formed up to the upper surface of the release liner S by the press roll 50, and the release liner S is entirely wound by the winding section 22 instead of being taken out. The plate member 20 serves as a peel plate. In this embodiment, sticking operation is carried out by machine automatically. Therefore, when forming the label L, the projected portion S1 serving as the sheet peel-off tip does not have to be formed on a part of the peripheral edge of the release liner S, accordingly the cutter blades 55A and 55B do not have an area with relatively low height portion. Other arrangements are identical to those of the first embodiment.

To this end, this embodiment enables to perform label sticking operation automatically instead of manual operation by a worker, and thus label sticking function can be added to the printer 10.

### Fifth Embodiment

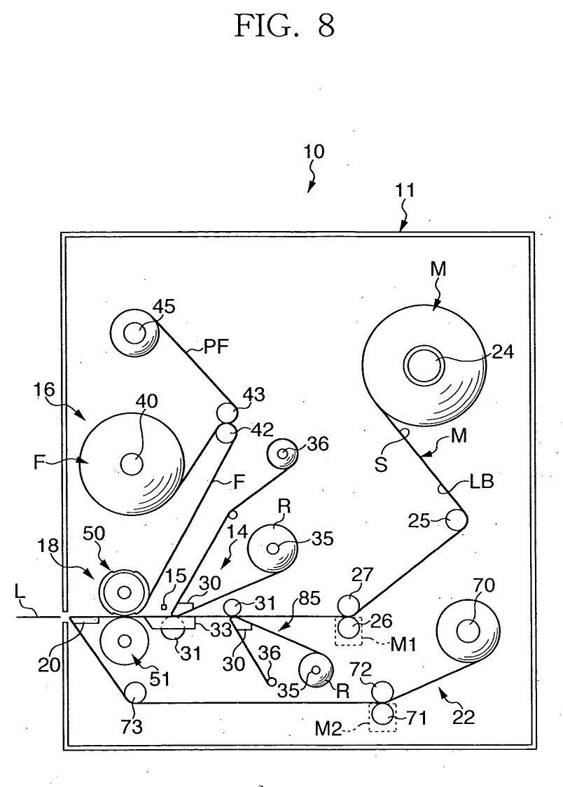

FIG. 8 shows a fifth embodiment of the invention. This embodiment is characterized in that an auxiliary printing section 85 having a substantially same arrangement as that of the above-described printing section 14 is provided at the release liner S side. The identical reference numerals to those of the printing section 14 are given to the auxiliary printing section 85 and the descriptions thereof are omitted. The auxiliary printing section 85 prints the same information as that printed on the label base LB or auxiliary information different therefrom; for example, bar codes or the like used by manufacturer for controlling products, or possibly products controlling data required for administrative record in later stage. A sensor for detecting the printing may be provided at the downstream side adjacent to the auxiliary printing section 85 so that similar effect is obtained as the print detection in the printing section 14 of the above-described embodiment.

### Sixth Embodiment

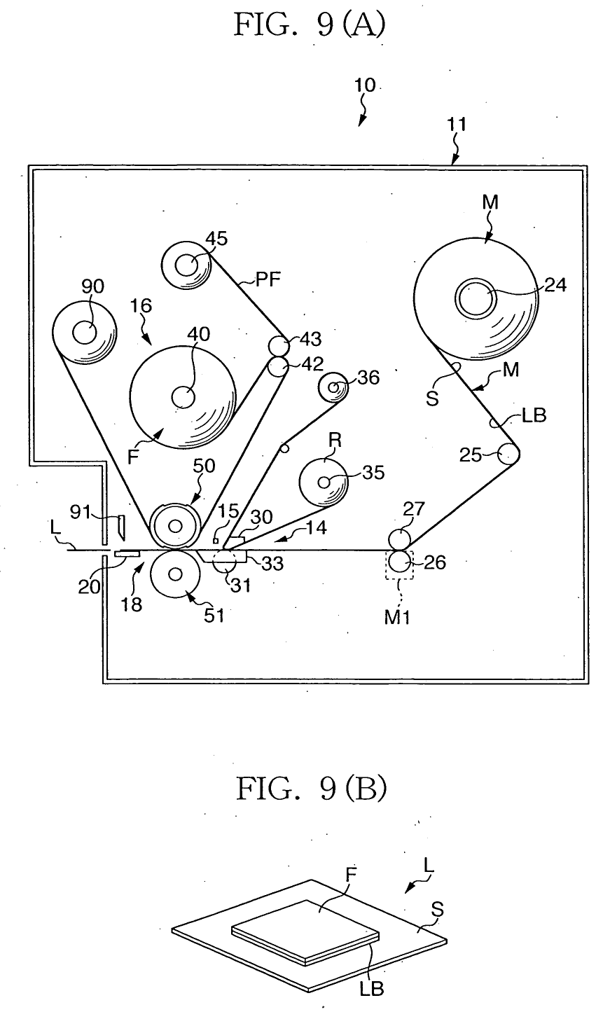

FIG. 9 shows a sixth embodiment of the invention. This embodiment is arranged in such a way that the winding section 22 in the first embodiment is eliminated, on the other hand a winding roll 90 is separately provided for winding the outer refuse portion of the label forming area of the protective film F, which is stuck on the label base LB, and the release liner S passed through the sticking section 18 is cut by a sheet cutter 91 to form labels L. The plate member 20 is arranged so as to serve as a cutter receiver. In this case, the press roll 50 serves as a sticking roll of the protective film F and a die cut roll for forming the cut C, and in addition to these, serves as a winding roll of refuse part as well. Other arrangements are substantially identical to those in the first embodiment.

According to the sixth embodiment, as shown in FIG. 9(B), the label L is formed in such a way that the label L is protected by the protective film F in the central area of a release liner S having substantially square shape.

### Seventh Embodiment

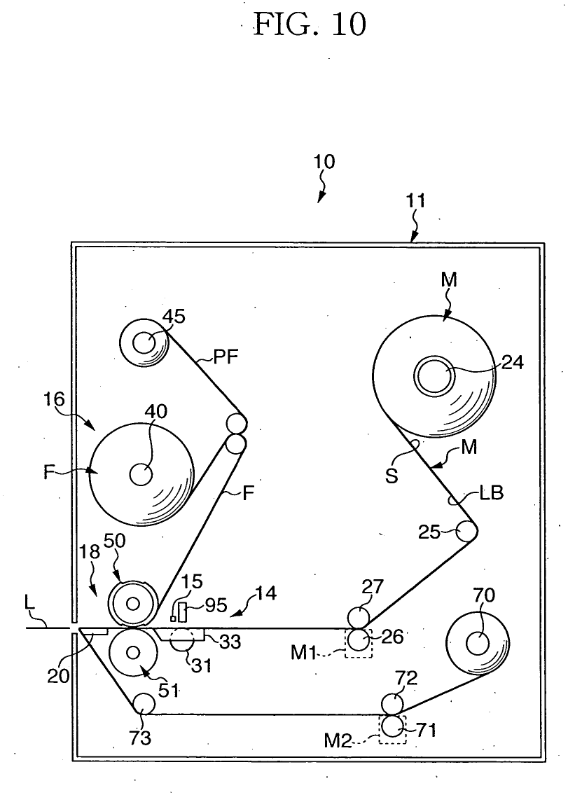

FIG. 10 shows a seventh embodiment of the invention. This embodiment is characterized in that the printing section 14 is provided with a non-contact type printer, for example, an ink injection printer 95. This embodiment also achieves the same effects as those in the second embodiment.

Although the best arrangements and method and the like for carrying out the invention have been disclosed in the above descriptions, the invention is not limited thereto.

That is, the invention has been illustrated and described particularly with respect to specific embodiments. However it is possible for those skilled in the art to add various modifications to the above-described embodiments such as configuration, material, quantity and other detailed arrangements without departing from the technical spirit of the invention and the scope of the object thereof.

Accordingly, the descriptions disclosed above defining the configuration and the like are given for illustrative purpose only to facilitate the understanding of the invention, and not intending to limit the invention. Any description using other appellations of members excluding a part or all of limitations with respect to the configuration and the like thereof should be included in the present invention.

For example, in the above embodiments, when a printing fault is detected, sound notification may be given via an alarm device (not shown). Or such an arrangement may be adopted that an independent stamping device is provided to give an appropriate fault mark on a faulty print surface.

Also, the number of the cutter blades 55A and 55B provided to the press roll 50 is not limited as the embodiments described so far, but the number of the labels obtained by one rotation may be further increased.

Furthermore, the soft member wound around on the roll body 52 of the press roll 50 is not particularly limited, but any soft member may be employed if it is deformable in the thickness direction by compression while imparting a specific sticking pressure.

1. A roll, comprising:
a soft member wound around the outer periphery of a roll body; and
cutter blades disposed within an area of the soft member, wherein
the roll sticks a protective film to a label base and forms a cut of a label shape.

2. The roll according to claim 1, wherein height of said cutter blade is set to be lower than a surface height position of said soft member, and when said soft member receives a compression force, said cut is formed by the cutter blade.

3. The roll according to claim 1 or 2, wherein said roll is formed in a configuration including a relatively low height area of said cutter blades to form a projected portion serving as a sheet peel-off tip on a part of the peripheral edge of the label.

4. A printer, comprising:
a pay-out section for paying out a strip of label sheet temporarily stuck with a label base on one surface of a release liner;
a printing section for printing on the surface of said label base while paying out the strip of label sheet from the pay-out section;
a film feeder for supplying a strip of protective film to the printed surface side of said label base; and
a sticking section for sticking said protective film to the label base, wherein
said sticking section includes a press roll and a platen roll opposing to the press roll, wherein
said press roll is wound with a soft member on the peripheral portion of the roll body, and cutter blades are disposed within an area of the soft member,
when said label sheet and protective film pass through said sticking section, the protective film is stuck to said printed surface side and a cut corresponding to a prescribed label shape is formed.

5. The printer according to claim 4, wherein said printing section prints individual identifiable printing information on each label.

6. The printer according to claim 4, wherein a sensor is disposed at the downstream side of said printing section, when the sensor detects a printing fault, said printing information at the point of time when the printing has been judged as faulty printing is printed, without printing a successive printing information.

7. The printer according to any of claim 4 to claim 6, wherein a plurality of said cutter blades are provided in the peripheral portion of said roll body, and a plurality of labels are formed by one rotation of the roll body.

8. The printer according to claim 7, wherein, when said sensor detects a printing fault, the drive rotation of said press roll is temporarily stopped, and said release liner, label sheet and protective film are wound including the area of printing fault without forming said cut in the area of printing fault.

9. The printer according to claim 7, wherein, when said sensor detects a printing fault, said press roll shifts its axle and is held so as not to form said cut.

10. The printer according to claim 8, wherein, when said sensor detects a printing fault, said press roll shifts its axle and is held so as not to form said cut.
